(19) United States
(12) Patent Application Publication
(10) Pub. No.: US 2007/0011902 A1
(43) Pub. Date: Jan. 18, 2007

(54) Spinner reducer for long john covers

(76) Inventor: James Scott Johnston, Louisville, KY (US)

Correspondence Address: MIDDLETON & REUTLINGER, 2500 BROWN & WILLIAMSON TOWER, LOUISVILLE, KY, 40202, US

(21) Appl. No.: 11/251,648

(22) Filed: Jan. 11, 2006

Related U.S. Application Data
(60) Provisional application No. 60/698,460, filed on Jul. 13, 2005.

(51) Int. Cl. F26B 17/30; A01F 25/12

(52) U.S. Cl. 34/58; 34/240

(57) ABSTRACT

An adapter is disclosed which allows for the removable attachment of a shorter and narrower roller cover to a standard patent apparatus spinner drier. The adapter device removably attaches to the spinning end of a spinner mechanism and has at an opposite end an attachment mechanism for receipt into a narrow cover roller so that the small cover roller may be spun dry at high speeds and removed from the spinner. The adapter fits a standard spinner and allows a smaller nap roller to be attached thereto.

### BACKGROUND OF THE INVENTION

The present invention is directed towards a drying spinner device for drying cleaned rollers and paintbrushes and in particular an adapter for a standard drying spinner device for utilizing a standard sized roller and brush drying spinner with a small diameter roller and in particular an adapter for attachment of a small diameter roller to a roller and brush spinner drying mechanism.

### BRIEF DESCRIPTION OF THE DRAWINGS

FIG. 1 is a perspective view of the combined roller and brush spinner with the spinner adapter and the small diameter roller of the present invention;

FIG. 2 is a close-up perspective view of the spinner adapter of the present invention;

FIG. 3 is a perspective view of the spinner adapter of the present invention attached to a small diameter roller.

### DETAILED DESCRIPTION OF THE PREFERRED EMBODIMENT

The present invention is directed towards a spinner adapter 10 which allows attachment of a small diameter and length roller 19, commonly referred to as long john or little john rollers, directly to a roller and brush spinner device 20. In normal use, a roller and brush spinner device 20 is utilized in order to spin dry a standard nearly 2 inch wide, 9 inch long roller cover by insertion of the standard roller cover around the first and second compression fingers 24, 25. After installation of the standard size roller cover, reciprocating motion of the handle 22 causes high speed rotational movement of the first and second compression fingers 24, 25 at the rotating end of the spinner 20 to spin the roller cover attached to the rotating end of the roller and brush spinner 20 at high speed. Within the interior of the spinner housing 21 is a drive mechanism which translates the reciprocating motion of the handle 22 to rotational movement imparted upon the rotational end of the spinner at compression fingers 24, 25 which extend outward from the rotating end of the roller and brush spinner 20. Fingers 24, 25 are inserted into the interior cylinder of the standard 9 inch cover and are frictionally retained therein. Outer fingers 26, 27 compress downward onto the outer surface of the cover to aid in maintaining its position. Common drawbacks for such a design is that the compression fingers 24, 25 of the roller and brush spinner 20 fit only a single size roller cover, namely a standard 9 inch roller cover which has an inner diameter available of approximately 2 inches, or more accurately 1 7/16 inch width. The matting for the standard size roller cover is then spun dry after attachment to the roller and brush spinner after washing and cleaning.

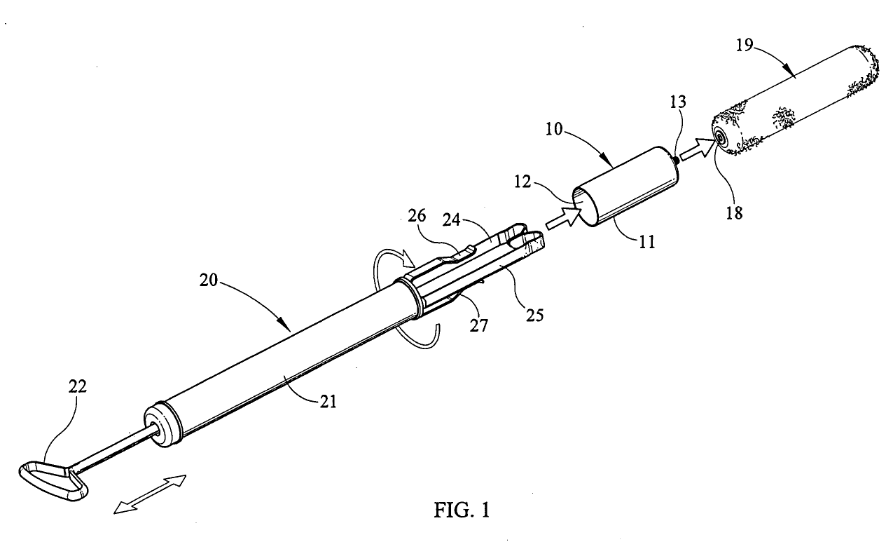

Additional use of the roller and brush spinner 20 depicted in FIG. 1, is to attach a paintbrush or similar article in between the ends of first and second compression fingers 24, 25 in order to similarly spin dry the paintbrush after it has been cleaned. The roller and brush spinner has the compression fingers 24, 25 which therefore can receive either a brush in between the end of the fingers or a standard large diameter roller cover in order to spin dry either type painting implement.

As indicated, a drawback of the standard roller and brush spinner design 20 depicted in FIG. 1, is that smaller rollers covers 19, shown in FIG. 1, which are smaller in diameter and in length, do not fit on the compression fingers 24, 25 or have an end aperture or opening which can receive such fingers. One alternative may be to forceably fit the smaller diameter roller cover 19 in between both of the first and second compression fingers 24, 25 such that each of the fingers compresses against an outer surface of the smaller diameter roller 19. Such implementation however damages the matting or nap of the small diameter roller cover 19 and may make continued use of such roller cover impractical. However, the small diameter rollers 19, as shown in FIG. 1, can be reused similar to paintbrushes and other roller cover painting articles. Thus, it is desirable to provide a mechanism which allows for attachment of the smaller roller cover 19 directly to a standard roller and brush spinner 20.

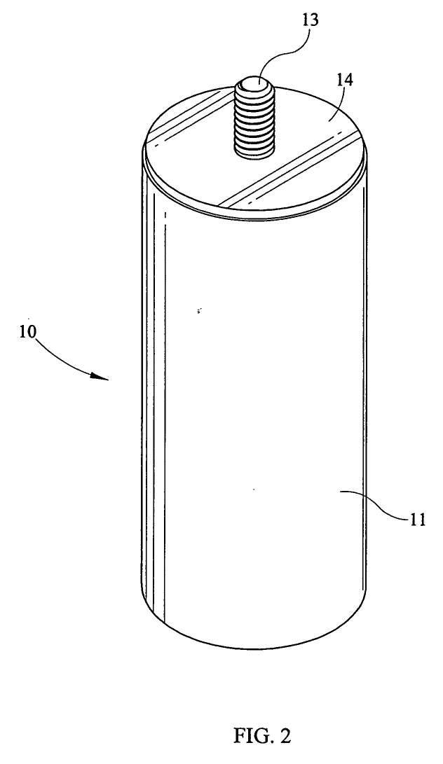

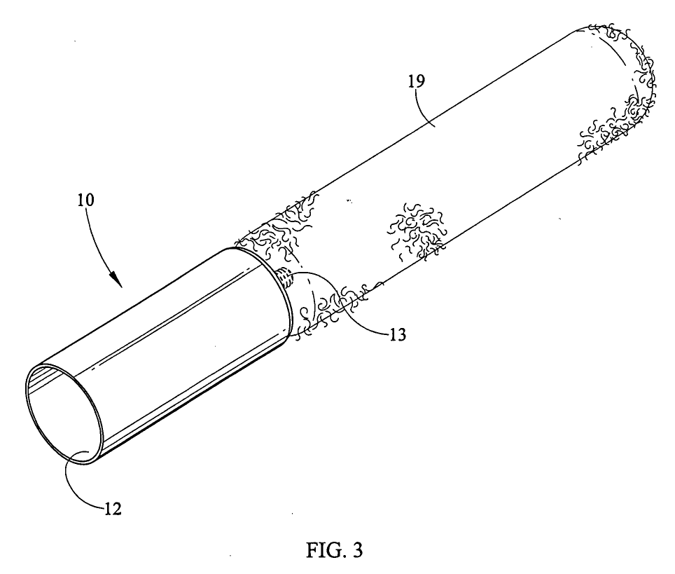

A spinner adapter 10 of the present invention is depicted which acts as a spinner reducer for small diameter roller covers and allows for direct attachment of the small diameter roller cover 19 to a standard roller cover and brush spinner 20. The spinner adapter 10 of the present invention, as shown in FIGS. 1, 2 and 3 provides the ability to directly and removably attach a small diameter and length roller cover 19 to a standard roller cover and brush spinner 20 such that reciprocating motion of handle 22 allows for high speed rotational movement of the smaller roller cover 19 thereby drying the roller after cleansing. The spinner adapter 10 of the present invention is comprised of a cylindrical sidewall 11 which may have an open cylindrical interior 12. The open cylindrical interior 12 may have a width of approximately 1 7/16 inches in order to appropriately receive therein the first and second compression fingers 24, 25 extending outwardly from rotating or spinning end the roller cover and brush spinner mechanism 20. The spinner adapter 10 of the present invention allows for secure affixation of the spinner adapter 10 directly to the rotating end of the roller and brush spinner 20.

Extending outward from the opposite end of the spinner adapter 10 of the present invention is an attachment mechanism 13, depicted in this embodiment as a threaded stud. While the attachment mechanism 13 depicted in the figures is a threaded stud, many other various attachment mechanisms may be utilized for securely and removably attaching the spinner adapter 10 to a small diameter roller cover 19 and the exemplary embodiment depicted herein should not be considered limiting in nature.

Extending outward from said opposite end of the spinner adapter 10 therefore is the attachment mechanism 13 depicted as a threaded stud which fits securely into a lined aperture 19 of a smaller diameter roller cover 19. The spinner adapter 10 of the present invention is formed of a cylindrical wall 11 which extends about 3 inches in length and which has a head plate 14 opposite the cylindrical open interior end fitting with the roller cover and brush spinner mechanism 20. The cylindrical wall 11 extends approximately 3 inches in length, as indicated, and has a head plate 14 which secures the attachment mechanism 13 to the spinner adapter. The cylindrical wall 11 may be made of any rigid material, such as plastic, metal or paperboard, the head plate 14 may be similarly constructed. As is readily apparent however, many different designs of the cylindrical wall and attachment mechanisms may be utilized which may not necessarily require a head plate 14 or other construction. The design of this exemplary embodiment is meant merely to provide the function of attaching a smaller diameter roller cover 19 directly to the rotating end of a roller and brush spinner.

The spinner adapter 10, presently described in this embodiment, has an open interior which receives the first and second compression fingers 24, 25 and, at an opposite end, has an outwardly extending attachment mechanism 13, in this embodiment of threaded stud. The attachment mechanism 13 can be threaded directly into the lined aperture 18 of the small diameter roller cover 19 such that the small diameter roller cover 19 is directly affixed to the rotating end of the roller cover and brush spinner. Aperture 18 is typically lined with a plastic or other type of sleeve on most short covers of this type which readily receives the stud 13 or other attachment mechanism. Reciprocating movement of the handle 22 of the spinner 20 imparts significant rotational movement on the small diameter roller cover 19 by virtue of the spinner adapter 20 allowing the small diameter roller cover 19 to be directly affixed to the rotating end of a paintbrush spinner drying mechanism 20, as is shown in the figures.

The attachment mechanism, as is shown, is depicted as a threaded stud 13 which may be 5/16 inch in diameter and have coarse threads and may have a length of approximately ½ inch. The attachment mechanism 19 provides a means for direct and removable affixation of a small diameter roller cover or long john cover, as is commonly called, to a cover spinner which, as previously indicated, does not provide adapting mechanisms for attachment to a shortened or narrow diameter long john cover. These long john covers typically are 4-3 inches or shorter in length and do not readily attach to a spinner device 20 as is shown.

Many variations may be provided based upon the teachings disclosed herein which do not vary or depart significantly from the teachings hereof. Such variations and modifications are considered to fall within the scope of the claims appended hereto and one of ordinary skill in the art reviewing the entire application, including claims, teachings, examples and figures will understand that such modifications for adapting a small diameter roller cover to a standard roller cover and brush spinner apparatus fall within the teachings hereof and the scope of the appended claims.

I claim:

1. A spinner reducer for a small diameter roller cover, comprising:
a cylindrical side wall having an open annular aperture at a first end and a head plate at an opposite end, an attachment mechanism extending outward from said head plate;
said spinner reducer defined by said cylindrical side wall and affixed to a rotational end of a roller cover and brush spinner mechanism, said rotational end of said roller cover and brush spinner mechanism having at least one finger for attachment to said cylindrical wall, said roller cover and brush spinner mechanism having a reciprocating handle at an opposite end;
a small diameter roller cover affixed to said attachment mechanism of said spinner reducer and removably affixed thereto such that high speed rotational movement of said at least one compression finger of said roller cover and brush spinner imparts high speed rotational movement directly to said small diameter roller cover and further wherein said small diameter roller cover may be removed from said spinner reducer, said spinner reducer removably retained on said roller cover and brush spinner mechanism.

7. The spinner reducer of claim 1 wherein said roller cover and brush spinner mechanism has a first and a second compression finger in opposing alignment, said first and said second compression finger fitting securely within said cylindrical side wall of said spinner reducer.

8. The spinner reducer of claim 2 wherein said first and second compression finger frictionally engage an interior surface of said cylindrical side wall thereby allowing said spinner reducer to rotate at significantly high rotational speeds without slipping.

9. A spinner adapter in combination with a roller cover and brush spinner for allowing high speed rotational movement of a small diameter roller, comprising:
a roller cover and brush spinner having a reciprocating handle and a high speed rotational spinning end, said high speed rotational spinning end having a first and second attachment arm;
a spinner adapter removably affixed to said first and second attachment arm of said roller cover and brush spinner, said spinner adapter removably affixed to a small diameter roller having a lined aperture by an attachment mechanism extending outward from a first end of said spinner adapter, said attachment mechanism extending outward from a top plate, said attachment mechanism having a threaded surface, said threaded surface fitting into said lined aperture of said small diameter roller cover and removable from said lined aperture;
whereby reciprocating movement of said handle of said roller cover and brush spinner imparts high speed rotational movement of said small diameter roller cover by virtue of said spinner adapter, said spinner adapter removable from said rotational end of said roller cover and brush spinner, said small diameter roller removable from said spinner adapter.

10. A spinner adapter in combination with a roller cover and brush spinner, comprising:
a roller cover and brush spinner having a reciprocating handle at a first end and a rotating end an opposite end, said rotating end having a first and a second compression finger in opposing relationship and also having a first and a second holding finger in 90° offset relation to said first and second compression finger;
a spinner adapter having a cylindrical wall and an attachment mechanism extending outward from a first end, said spinner adapter having an open second end defined by said cylindrical wall, said open second end removably receiving said first and second compression finger, said first and second holding fingers of said roller and brush spinner compressing on an outer surface of said cylindrical wall of said spinner adapter;
said attachment mechanism extending outward from said spinner adapter and removably received within a lined aperture of said small diameter roller cover, said lined aperture of said small diameter roller cover being a plastic fitment within said small diameter roller cover and readily receiving said attachment mechanism.

11. A spinner reducer for small diameter roller, comprising:
a roller cover and brush spinner having a reciprocating handle extending outward from a first end and a rotating end at an opposite second end, said rotating end of said roller cover and brush spinner receiving a spinner adapter, said spinner adapter removably received on said rotating end of said roller cover and brush spinner and having an attachment mechanism for removably attaching said spinner adapter to a small diameter roller cover, said small diameter roller cover having an aperture for receiving said attachment mechanism, said spinner adapter designed to removably affix said roller cover and brush spinner to a closed end of said small diameter roller cover, said closed end small diameter roller cover receiving said attachment mechanism at said closed end and being dried by said roller cover and brush spinner by virtue of high speed rotational movement of said rotating end of said roller cover and brush spinner by reciprocating movement of said handle.
